(19) United States
(12) Patent Application Publication
(10) Pub. No.: US 2020/0188931 A1
(43) Pub. Date: Jun. 18, 2020

(54) ELECTRONIC DEVICE WITH ADVANCED CONTROL FEATURES

(71) Applicant: Pacific Air Filtration Holdings, LLC, Boulder, CO (US)

(72) Inventor: Igor Krichtafovitch, Kiev (UA)

(73) Assignee: Pacific Air Filtration Holdings, LLC, Boulder, CO (US)

(21) Appl. No.: 16/219,757

(22) Filed: Dec. 13, 2018

(51) Int. Cl. B03C 3/47; B03C 3/28

(52) U.S. Cl. CPC B03C 3/47; B03C 3/28

(57) ABSTRACT

An electrostatic device, for example, an electrostatic air cleaner, may be provided with a corona discharge electrode; a collecting electrode; a power source connected to the corona discharge electrode and to the collecting electrode; an electrical parameter sensor; and a power supply system. The control system may receive a signal from the electrical sensor. The control system evaluates the electrical performance of the system and initiates appropriate or corrective action.

### BACKGROUND OF THE INVENTION

### 1. Field of the Invention

The present invention relates to electrostatic devices and particularly to power supply control systems in devices having corona discharge.

### 2. Description of the Related Technology

Electrostatic devices such as electrostatic air filters contain a corona (or emitter) electrode that emits ions and a complementary electrode which is under a different electrical potential than the corona electrode. Ion emission takes place under certain conditions near a visual critical corona voltage or Corona Inception Voltage (CIV). A corona inception voltage should be present in the vicinity of the corona electrode or the corona electrode sharp edge (tip). This corona inception voltage (Vₒ) is given by Peek's law.

For the wire-like corona electrode:

Vₒ=mᵥ gᵥ r In(S/r);

Where Vₒ=corona inception voltage;

mᵥ=irregularity factor;

r=wire radius;

S=distance between two the corona wire and the opposite electrode;

δ=air density factor;

gᵥ is the critical electric field, calculated by equation;

gᵥ=g₀δ(1+C/(δr)^{-1/2}).

The corona inception voltage is affected by environmental factors such as air humidity, air temperature, and air contamination level. In more humid air, the corona inception voltage is lower than in dry air. In air containing dust or chemicals, the corona inception voltage may be higher or lower depending on the nature of the contaminants. For instance, the higher the dust load in the air, the higher the corona inception voltage.

The corona current Ic depends on the corona voltage Vc non-linearly with fair approximation according to the formula:

Ic=Io Vc(Vc−Vₒ);

where Io is a constant value that depends on the electrodes configuration. The Io value is also affected by the same factors that affect the corona inception voltage.

In most of the devices using corona discharge, such as an electrostatic air filter, the operating voltage level applied to the corona electrode should be between the corona inception voltage and the breakdown voltage. The breakdown voltage may also be affected by the factors listed above.

While higher corona voltage up to near the breakdown voltage usually results in higher air filtration efficiency, there are several undesirable consequences related to voltage value. First, with high corona voltage and current, the electrostatic device consumes more electrical energy. Second, maintaining voltage close to the breakdown level increases the probability and frequency of undesirable discharges like sparking, arcing, hissing and cracking. Ozone generation may also increase with the higher corona voltage level. The aging and contamination of corona electrodes also increases with the higher corona voltage level. The corona electrodes are subject to erosion and/or surface contamination due to intense electro-chemical processes induced by the corona discharge.

High air filtration efficiency is not the only goal for an electrostatic device such as an electrostatic air filter. In most cases, the incoming air is comparatively clean and the desired cleanness of the filtered air may be achieved with lower than maximum filtration efficiency. In any case, undesirable electrical discharges like sparking or arcing should be avoided.

### SUMMARY OF THE INVENTION

The electrostatic device using the corona discharge may have several types of electrodes. One type of electrode is a corona electrode. Another type may be collecting electrodes. There may be other types of electrodes such as an exciting electrode and a repelling electrode. Each type of electrode referred to herein may be a single electrode or plural electrodes. Typically, electrodes of the same type are kept at the same potential. The exciting electrode may be a single piece structure or more than one piece electrically connected to each other. The corona electrodes may be a corona wire routed across the air flow path one time or more than one time, and an electrostatic device may have one corona wire or multiple corona wires routed across an airflow path and electrically connected to each other. The term “electrode array” is intended to include one or more electrodes.

Performance of an electrostatic air filter may be enhanced by monitoring the corona voltage and current value. A control system may be responsive to the corona voltage and/or current.

Electrode contamination/degradation affects performance of an electrostatic device. As the contamination and/or degradation increase, higher voltages are required to reach corona onset. In time, the voltage requirement for corona onset will exceed a desired threshold or the capacity of the power supply.

The corona discharge in electrostatic devices such as air filters may be affected by processes expressed in different time frames and which are best addressed by different actions. One process is coronal electrode contamination and/or erosion. This slow speed process takes considerable time, usually weeks or months, and may affect the surface of a corona wire and/or the corona discharge.

If ambient conditions trigger a slow process change in filter operation, for example gradual wire contamination, the monitoring system may collect data on the corona voltage and current and store the data in a memory. The control system may average the data over a certain period of time (a week or so, but preferably longer than the medium processes time period) and may calculate the level of wire contamination (erosion) as a function of the corona current at a certain voltage, or the corona voltage to the corona current ratio. Since the electrostatic air filter's filtration efficiency depends on the corona current, i.e., the number of ions emitted into the air, the control system may increase or decrease the corona electrode voltage in order to restore the corona current (or power) value to the appropriate level.

The changes resulting from the condition of incoming air: humidity, temperature, dirtiness, and/or air density may be considered a medium speed process. These conditions change within days, hours or minutes.

If ambient conditions trigger a medium speed process change in filter operation, the power supply control may temporarily change the corona current value. The monitoring system may analyze that medium speed change as air conditions alter, and the control system may take action to increase or decrease the corona electrode voltage, or corona current, or corona discharge power to the necessary (in most cases, preset) level.

An undesirable and unpredictable electrical discharge-like spark may be considered a fast speed process. This condition may happen at any time and takes milliseconds to develop.

If, for example, ambient conditions trigger a fast process change in filter operation, the power may be instantly removed from the corona electrode or, at least, decreased to a safe level quickly. Power may be restored after the undesirable condition is removed; for example, the air in the vicinity of the corona electrode is deionized. In the case of frequent or persisting sparking, the voltage across the corona electrode may be decreased to a level at which no sparks happens or, at least, they happen at lower repetition frequency.

An electrostatic device may have a corona electrode array, a second electrode array associated with the corona electrode array, a power source connected to the corona electrode array and to the second electrode array, an electrical sensor(s) connected to the power source, a power source controller connected and responsive to said electrical sensor(s), and wherein the power source may be connected and responsive to the power source controller and wherein the power source controller operates in at least two modes but may operate in three modes. The power source controller may have a memory containing data corresponding to an electrical measurement by the electrical sensor and a processor connected to the memory that analyzes data corresponding to the electrical measurement and controls the power source in response to analysis of the data. The first (fast) mode of control of the power source may be initiated upon detecting a power condition representing a spark or pre-spark condition. The first mode of control may substantially decrease the voltage applied to the electrodes and after a delay substantially increases the voltage applied to the electrodes. The power source controller may execute a second (medium) mode control of the power source upon detecting a change in power indicative of a change in environmental or operational conditions. The second mode control of the power source may adjust an operational level to compensate for a change in environmental or operational conditions. The power source controller may execute a third (slow) mode in response to a change in the data indicative of a maintenance condition of the electrostatic air filter. The third mode may include issuing a maintenance signal.

The second electrode of the electrostatic air cleaner may be a collecting electrode array.

Performance of an electrostatic air filter may be enhanced by monitoring the corona voltage and current values. A control system may be responsive to the corona voltage and/or current. The corona discharge in electrostatic devices such as electrostatic air filters may be affected by processes expressed in different time frames and which timing processes are best addressed by different actions. The third mode or process is coronal electrode contamination and/or erosion. This process takes considerable time; usually weeks or months to affect the surface of a corona wire and affect the corona discharge. Electrode contamination/degradation affects performance of an electrostatic device. As the contamination and degradation increase, higher voltages are required to reach corona onset voltage. In time the voltage requirement for corona onset will exceed a desired threshold or the capacity of the power supply.

If ambient conditions trigger a slow process change in filter operation, for example, gradual wire contamination, the monitoring system may collect data on the corona voltage and current and store data in a memory. The control system may average the data over a certain period of time (a week or so, but preferably longer than the medium processes time period) and may calculate the level of wire contamination (erosion) as a function of the corona current at a certain voltage, or the corona voltage to the corona current ratio. Since the electrostatic air filter's filtration efficiency depends on the corona current, i.e., the number of ions emitted into the air, the control system may increase or decrease the corona electrode voltage in order to restore the corona current (or power) value to an appropriate level.

The changes resulting from the condition of incoming air: humidity, temperature, dirtiness, and air density may be considered as a medium speed process (or mode). These conditions change within days, hours or minutes.

If ambient conditions trigger a medium speed process change in filter operation, the power supply control may temporarily change the corona current's value. The monitoring system may analyze that medium speed change as air conditions alter and the control system may take action to increase or decrease the corona electrode voltage, or corona current, or corona discharge power to the necessary (in most cases, preset) level.

An undesirable and predictable electrical discharge-like spark is a fast process or mode. This may happen at any time and takes milliseconds to develop. If, for example, ambient conditions trigger a fast process change in filter operation, the power may be instantly removed from the corona electrode or, at least, decreased to a safe level quickly. Power may be restored after the undesirable condition is removed; for example, the air in the vicinity of the corona electrode is deionized. In the case of frequent or persisting sparking, the voltage across the corona electrode may be decreased to a level at which no sparks happen or, at least, they happen at lower repetition frequency.

Various objects, features, aspects, and advantages of the present invention will become more apparent from the following detailed description of preferred embodiments of the invention, along with the accompanying drawings in which like numerals represent like components.

Moreover, the above objects and advantages of the invention are illustrative, and not exhaustive, of those that can be achieved by the invention. Thus, these and other objects and advantages of the invention will be apparent from the description herein, both as embodied herein and as modified in view of any variations which will be apparent to those skilled in the art.

### BRIEF DESCRIPTION OF THE DRAWINGS

FIG. 1 shows a block diagram of the proposed invention.

FIG. 2 shows a time diagram of the corona discharge current and voltage.

### DETAILED DESCRIPTION OF THE PREFERRED EMBODIMENT

Before the present invention is described in further detail, it is to be understood that the invention is not limited to the particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

It must be noted that as used herein and in the appended claims, the singular forms “a”, “an”, and “the” include plural referents unless the context clearly dictates otherwise.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

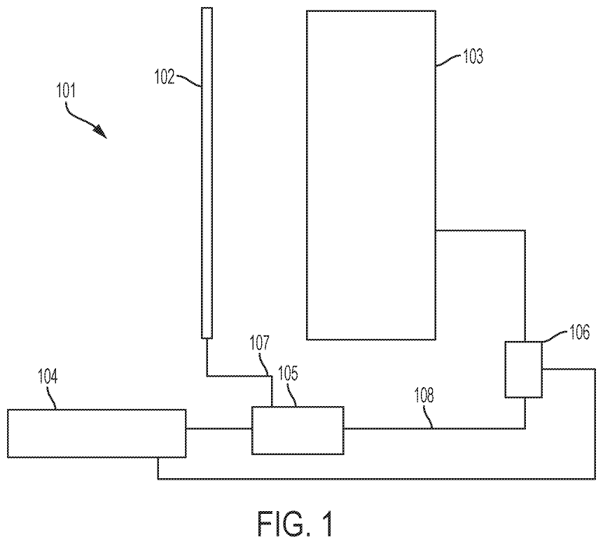

FIG. 1 schematically shows an electrostatic air filter 101. The electrostatic air filter may have a corona electrode 102 and a collecting electrode 103. The corona electrode 102 may be connected to the high voltage terminal 107 of a power source 105. The low voltage (ground) terminal 108 of the power source 105 may be connected to the collecting electrode 103 through a current sensor 106. The current sensor 106 may be a shunt, a current transformer, a Hall Effect sensor, or any other current sensing device. The current sensing unit 106 may be connected to a control system 104 that controls the power source 105 voltage output magnitude across terminals 107 and 108.

The control system may include a microprocessor that performs the following actions:
Measures the corona current value from the corona current sensor 106;
Measures the output voltage of the power source 105. This may be a direct measurement or a measurement across a voltage divider (not shown), or any other method for voltage measurement known in the art;
Stores the results of both measurements in a memory;
Changes the voltage generated by the power source 105 in accordance with a built-in algorithm.

The algorithm itself may be based on the above-mentioned reasoning and may be a built-in microprocessor adjusted for the course of the electrostatic filter performance or adjusted to the specific use. For instance, the electrostatic filter may be used in rather clean air and use one kind of appropriate algorithm, or the electrostatic filter may be used in industrial area with heavy smog and use a different algorithm.

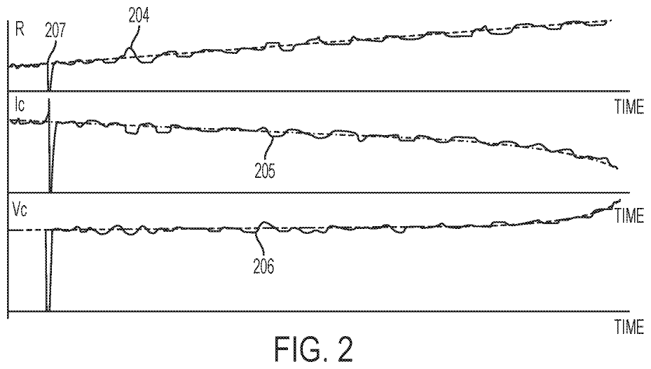

FIG. 2 schematically shows electrical parameters of a corona discharge device. R is the corona discharge resistance, Ic represents the corona current and VC represents the corona voltage. Initially, nominal voltage is applied to the corona electrodes and the corona current starts to flow. The corona current magnitude (value) is depicted by the curve 205, the corona electrode voltage is depicted by the curve 206. The ratio of Vc to Ic is equal to the corona discharge resistance R (204). As can be seen from these curves, the corona current changes its value depending on the air conditions such as temperature, humidity, density and so forth. These changes refer to the medium processes category. In order to maintain proper (desirable) electrostatic air filter performance (like filtration efficiency or filtered air cleanness) the control system changes the power source voltage Vc (206) in response to the corona current Ic (205) changes.

The moment spark discharge happens is shown as 207. Current Ic abruptly increases while the resistance R drops almost to zero. This is a fast process. In response to the fast current change, the control system sharply decreases the voltage Vc value. This voltage is kept at low level for several seconds until the air near the corona electrode deionizes. Then, the control system restores the power source operation back to pre-spark level. In the course of further operations, the corona current Ic changes its value at a medium processes speed and the control system adjusts the power source voltage correspondingly. As may be noticed, the resistance R steadily increases its value over the course of time. The corona current steadily drops in value and the control system steadily increases the power source voltage. These steady (average) changes belong to the slow processes category. The control system stores the collected data and sets medium (up and down) process changes apart from slow processes. Slow process usually goes in one direction (increase or decrease the value over the time).

Over time, the corona current will decrease to the point where the corona voltage increases to its maximum or a threshold level as shown in FIG. 2 at the far right of the graph. The control system may generate a warning signal which may be used to alert a user to take appropriate actions, like replacing or cleaning the corona wire.

According to another feature, when the control system detects operational parameters exceeding a threshold, the control system may signal a user and/or switch the power source off. The operational parameters may include the potential of the corona electrode, or excessive spark conditions.

The techniques, processes and apparatus described may be utilized to control operation of any device and conserve use of resources based on conditions detected or applicable to the device.

The invention is described in detail with respect to preferred embodiments, and it will now be apparent from the foregoing to those skilled in the art that changes and modifications may be made without departing from the invention in its broader aspects, and the invention, therefore, as defined in the claims, is intended to cover all such changes and modifications that fall within the true spirit of the invention.

Thus, specific apparatus for and methods of the current invention have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. An electrostatic device comprising:
a corona electrode array;
a second electrode array associated with said corona electrode array;
a power source connected to said corona electrode array and to said second electrode array;
an electrical sensor connected to one of said corona electrode array and said second electrode array;
a power source controller connected to said power source and to said electrical sensor; and
wherein said power source controller is configured to:
(a) make a plurality of readings over a long time from said electrical sensor, store said readings, make a first evaluation of a plurality of said readings stored over a long time, and signal results of said first evaluation;
(b) make a plurality of readings over a medium time from said electrical sensor, store said readings over a medium time from said sensor, make a second evaluation of said readings over a medium time and adjust operation of said power source based on said second evaluation of said readings over said medium time, and
(c) make a plurality of readings of said electrical sensor and, in response to detection of a substantial change in said readings, substantially reduce an output of said power source and after a delay, restore said output of said power source.

2. (canceled)

3. (canceled)

4. The electrostatic device according to claim 1 wherein said substantial change in said readings represents a spark or pre-spark condition.

5. (canceled)

6. The electrostatic device according to claim 4 wherein said second evaluation of said readings over a medium time frame is responsive to a change in environmental or operational conditions.

7. (canceled)

8. The electrostatic device according to claim 6 wherein said first evaluation of said plurality of said readings stored over a long time is responsive to a change in said readings indicative of a maintenance condition of said electrostatic device.

9. The electrostatic device according to claim 8 wherein said power source controller is further configured to issue a maintenance signal.

10. The electrostatic device according to claim 1 wherein said electrostatic device is an electrostatic air cleaner and wherein said second electrode array is a collecting electrode array.
